(19) United States
(12) Patent Application Publication
(10) Pub. No.: US 2017/0336811 A1
(43) Pub. Date: Nov. 23, 2017

(54) FLOW CONTROL DEVICE DESIGN FOR WELL COMPLETIONS IN AN OILFIELD

(71) Applicant: Schlumberger Technology Corporation, Sugar Land, TX (US)

(72) Inventors: Terry Wayne Stone, Abingdon (GB); Kashif Rashid, Wayland, MA (US); William J. Bailey, Somerville, MA (US); Peter Wardell-Yerburgh, Abingdon (GB); Peter Tilke, Watertown, MA (US)

(21) Appl. No.: 15/156,573

(22) Filed: May 17, 2016

(51) Int. Cl. G05D 7/06; E21B 34/06; E21B 41/00; G06F 17/50

(52) U.S. Cl. CPC G05D 7/0676; G06F 17/5009; E21B 34/06; E21B 41/0092

(57) ABSTRACT

A method, apparatus, and program product generate a flow control device design for well completions in one or more wells of an oilfield in part by equipping a reservoir simulation model with multiple flow control device proxies represented by one or more generalized expressions for pressure drop including multiple tunable parameters associated with various physical flow control devices. Multiple reservoir simulations are then run using the reservoir simulation model to optimize an objective function based on at least a subset of the tunable parameters such that an optimal set of values determined from the optimization may be used to select flow control device types for the well completions.

### BACKGROUND

Various types of flow control devices (FCDs) may be installed in a wellbore in order to improve overall oilfield productivity and economic value, e.g., to control water production and/or improve sweep efficiency. For example, Inflow Control Devices (ICDs) are static in nature, and choke back inflowing fluids with nozzles that remain fixed in aperture size during the entire production cycle or until the well is worked-over. Autonomous Inflow Control Devices (AICDs) are autonomous in nature, and adjust their aperture size autonomously in response to a changes in in-situ flowing conditions, including flow rate, density and/or viscosity of inflowing product. Flow Control Valves (FCV's) are active devices that can change their flowing area through independent and/or manual surface control. Regardless of the type of flow control device, however, a pressure drop across the flow control device is effectively regulated in response to flow rate, inflowing mixture density, water cut and/or inflowing mixture viscosity.

Flow control devices are generally incorporated into well completions that are installed within a wellbore to control production and/or injection. Generally, a particular type of flow control device is chosen for all wells in an oilfield under development, and there may be multiple devices installed within a single well, i.e., in different completions of a single well. Moreover, flow control devices may be installed in both production wells as well as injection wells. Static ICDs or autonomous AICDs are generally configured prior to production/injection based on productivity/injectivity assessments calculated from initial reservoir and fluid parameters such as permeability, porosity and fluid phase behavior or estimated from inflowing fluid properties in the case of AICDs. FCVs may have a fixed set of cross-sectional areas (apertures) or may have infinitely controllable apertures.

Selection of flow control devices for an oilfield can significantly impact recovery or economic benefit; however, particularly in oilfields expected to have many wellbores as well as many completions within each wellbore, which types of flow control devices are best suited for which wellbores and/or completions is not readily apparent. Wellbores and completions within a reservoir are interconnected so fluid flow through one completion of one wellbore may affect the fluid flow through other completions and/or wellbores. Furthermore, certain regions of a reservoir may possess different fluid compositions, varying from compositions predominantly composed of hydrocarbons to more watery compositions predominantly composed of water. As such, the varying density or viscosity of such compositions can necessitate different flow restrictions in different regions in order to manage in an optimal manner, the production of hydrocarbons. A significant need therefore exists in the art for optimizing the selection and/or control of flow control devices incorporated into well completions within an oilfield.

### SUMMARY

The embodiments disclosed herein provide a method, apparatus, and program product that generate a flow control device design for multiple well completions in one or more wells in an oilfield. A reservoir simulation model of at least a portion of the oilfield is equipped with multiple flow control device proxies, each associated with a well completion, and with the flow control device proxies represented by at least one generalized expression for pressure drop including multiple tunable parameters associated with one or more physical flow control devices. Multiple reservoir simulations are run using the reservoir simulation model to optimize an objective function based upon at least a subset of the tunable parameters to determine an optimal set of values for that subset of tunable parameters, and running the reservoir simulations includes applying the generalized expression for pressure drop using multiple sets of values for the subset of tunable parameters. Then, based at least in part on the determined optimal set of values, at least one flow control device type is selected for each well completion.

In some embodiments, the flow control device type is selected from an inflow control device (ICD), an autonomous inflow control device (AICD) and a flow control valve (FCV), and in some embodiments, the flow control device type is selected from various models of flow control devices. In some embodiments, running the reservoir simulations further includes determining an optimal value for one or more operating parameters for a flow control device type selected for a well completion, and in some embodiments, the operating parameter includes a cross-sectional area.

In some embodiments, running the reservoir simulations further includes determining a time parameter controlling when to switch a well completion from a first flow control device to a second flow control device or controlling when to change an operating parameter from a first value to a second value. Further, in some embodiments, the objective function incorporates the at least a subset of tunable parameters, one or more oilfield development values and one or more economic values.

Some embodiments also include selecting the at least a subset of tunable parameters from the tunable parameters by performing sensitivity analysis on the tunable parameters, and in some embodiments, performing sensitivity analysis on the tunable parameters includes sampling simulation results by running multiple reservoir simulations using the reservoir simulation model and differing values for each tunable parameter and determining a sensitivity for each tunable parameter based upon the sampled simulation results. In some embodiments, sampling simulation results includes selecting the differing values using a Monte-Carlo or pseudo-random algorithm.

Some embodiments also include tuning at least one flow control device proxy based on local flow conditions, and in some embodiments, the at least one generalized expression for pressure drop includes a respective generalized expression for pressure drop for each of the flow control device proxies, and the tunable parameters includes multiple tunable parameters for each of the respective generalized expressions for pressure drop. In some embodiments, at least one of the respective generalized expressions for pressure drop includes a generalized Bernoulli equation, and in some embodiments, the multiple tunable parameters for each of the respective generalized expressions for pressure drop includes a cross-sectional area parameter, a mixture density response parameter, a mixture viscosity response parameter and a flow rate response parameter.

In addition, some embodiments further include constraining one or more flow control device proxies prior to running the reservoir simulations based upon one or more of flow rate at an associated well completion, productivity of an associated well completion, or a physical constraint of an associated well completion. Some embodiments also include characterizing physical flow control devices with an associated set of values for at least a subset of tunable parameters, where selecting the at least one flow control device type includes matching the optimal set of values against the associated sets of values for physical flow control devices. Some embodiments also include installing and/or configuring a plurality of physical flow control devices in the oilfield based upon the selection of the at least one flow control device type for each well completion. In addition, in some embodiments, running the reservoir simulations to optimize the objective function further includes optimizing the objective function under geological and/or petro-physical uncertainty to identify multiple optimal solutions based at least in part on a non-utility-based criterion.

Some embodiments may also include an apparatus including at least one processing unit and program code configured upon execution by the at least one processing unit to generate a flow control device design in any of the manners discussed herein. Some embodiments may also include a program product including a computer readable medium and program code stored on the computer readable medium and configured upon execution by at least one processing unit to generate a flow control device design in any of the manners discussed herein.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 is a block diagram illustrating an example flow control device design system suitable for implementation in the data processing system of FIG. 1.

FIG. 6 is a flowchart illustrating an example sequence of operations for generating a flow control device design with the flow control device design system of FIG. 5.

FIG. 7 is a flowchart illustrating another example sequence of operations for generating a flow control device design with the flow control device design system of FIG. 5.

FIG. 8 is a block diagram functionally illustrating an example implementation of the select subset of optimization parameters operation referenced in FIG. 7.

### DETAILED DESCRIPTION

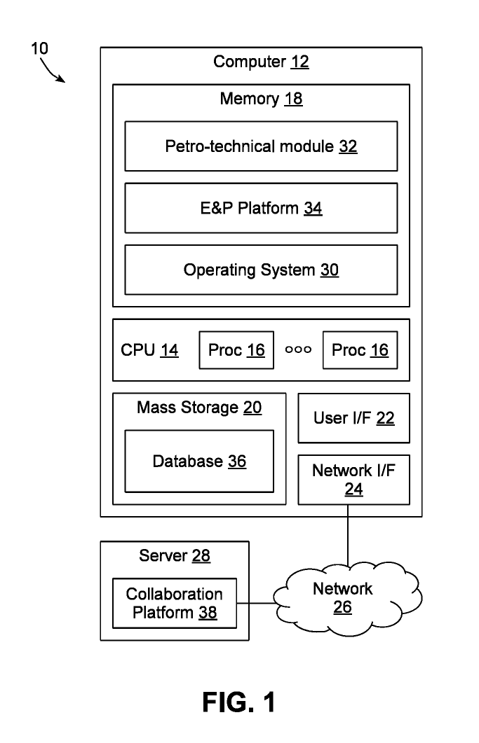

Turning now to the drawings, wherein like numbers denote like parts throughout the several views, FIG. 1 illustrates an example data processing system 10 in which the various technologies and techniques described herein may be implemented. System 10 is illustrated as including one or more computers 12, e.g., client computers, each including a central processing unit (CPU) 14 including at least one hardware-based processor or processing core 16. CPU 14 is coupled to a memory 18, which may represent the random access memory (RAM) devices comprising the main storage of a computer 12, as well as any supplemental levels of memory, e.g., cache memories, non-volatile or backup memories (e.g., programmable or flash memories), read-only memories, etc. In addition, memory 18 may be considered to include memory storage physically located elsewhere in a computer 12, e.g., any cache memory in a microprocessor or processing core, as well as any storage capacity used as a virtual memory, e.g., as stored on a mass storage device 20 or on another computer coupled to a computer 12.

Each computer 12 also generally receives a number of inputs and outputs for communicating information externally. For interface with a user or operator, a computer 12 generally includes a user interface 22 incorporating one or more user input/output devices, e.g., a keyboard, a pointing device, a display, a printer, etc. Otherwise, user input may be received, e.g., over a network interface 24 coupled to a network 26, from one or more external computers, e.g., one or more servers 28 or other computers 12. A computer 12 also may be in communication with one or more mass storage devices 20, which may be, for example, internal hard disk storage devices, external hard disk storage devices, storage area network devices, etc.

A computer 12 generally operates under the control of an operating system 30 and executes or otherwise relies upon various computer software applications, components, programs, objects, modules, data structures, etc. For example, a petro-technical module or component 32 executing within an exploration and production (E&P) platform 34 may be used to access, process, generate, modify or otherwise utilize petro-technical data, e.g., as stored locally in a database 36 and/or accessible remotely from a collaboration platform 38. Collaboration platform 38 may be implemented using multiple servers 28 in some implementations, and it will be appreciated that each server 28 may incorporate a CPU, memory, and other hardware components similar to a computer 12.

In one non-limiting embodiment, for example, E&P platform 34 may implemented as the PETREL Exploration & Production (E&P) software platform, while collaboration platform 38 may be implemented as the STUDIO E&P KNOWLEDGE ENVIRONMENT platform, both of which are available from Schlumberger Ltd. and its affiliates. It will be appreciated, however, that the techniques discussed herein may be utilized in connection with other platforms and environments, so the invention is not limited to the particular software platforms and environments discussed herein.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more hardware-based processing units in a computer (e.g., microprocessors, processing cores, or other hardware-based circuit logic), cause that computer to perform the steps embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, it will be appreciated by those of ordinary skill in the art having the benefit of the instant disclosure that the various operations described herein that may be performed by any program code, or performed in any routines, workflows, or the like, may be combined, split, reordered, omitted, and/or supplemented with other techniques known in the art, and therefore, the invention is not limited to the particular sequences of operations described herein.

Those skilled in the art will recognize that the example environment illustrated in FIG. 1 is not intended to limit the invention. Indeed, those skilled in the art will recognize that other alternative hardware and/or software environments may be used without departing from the scope of the invention.

### Oilfield Operations

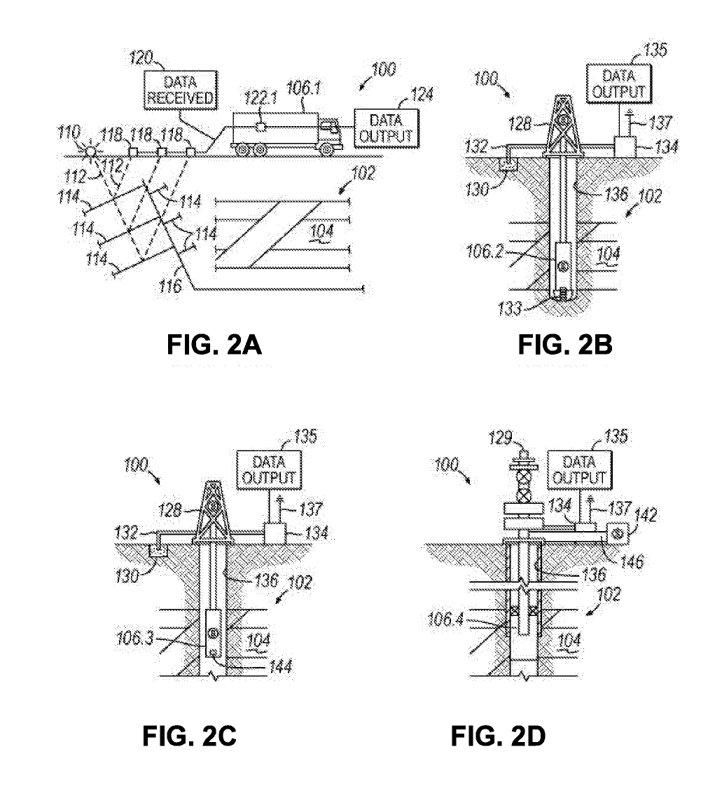

FIGS. 2A-2D illustrate simplified, schematic views of an oilfield 100 having subterranean formation 102 containing reservoir 104 therein in accordance with implementations of various technologies and techniques described herein. FIG. 2A illustrates a survey operation being performed by a survey tool, such as seismic truck 106.1, to measure properties of the subterranean formation. The survey operation is a seismic survey operation for producing sound vibrations. In FIG. 2A, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2C illustrates a wireline operation being performed by wireline tool 106.3 suspended by rig 128 and into wellbore 136 of FIG. 2B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2B-2D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2A-2D are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

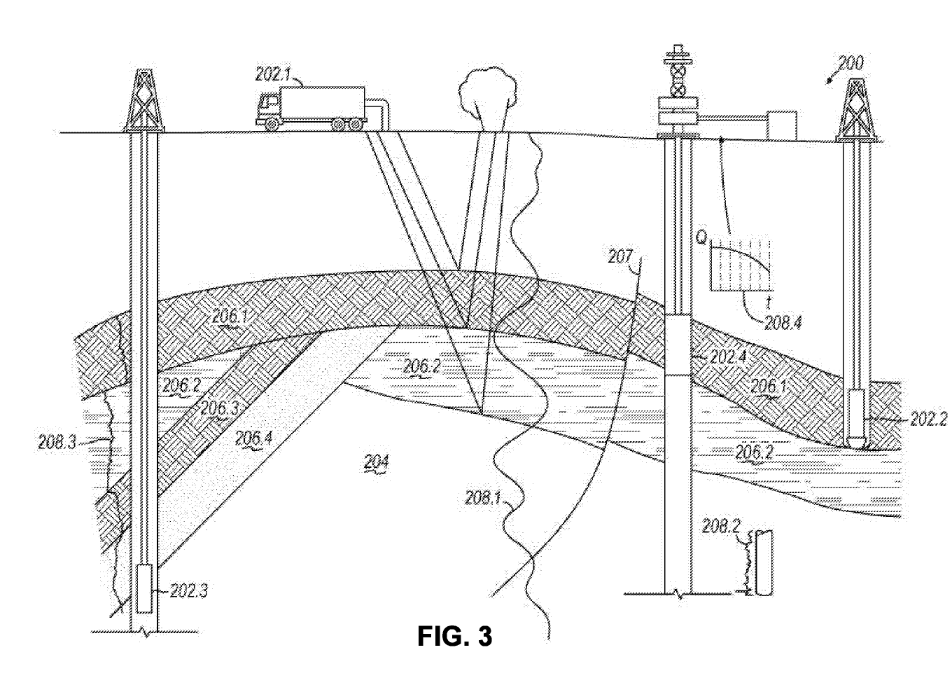

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2A-2D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

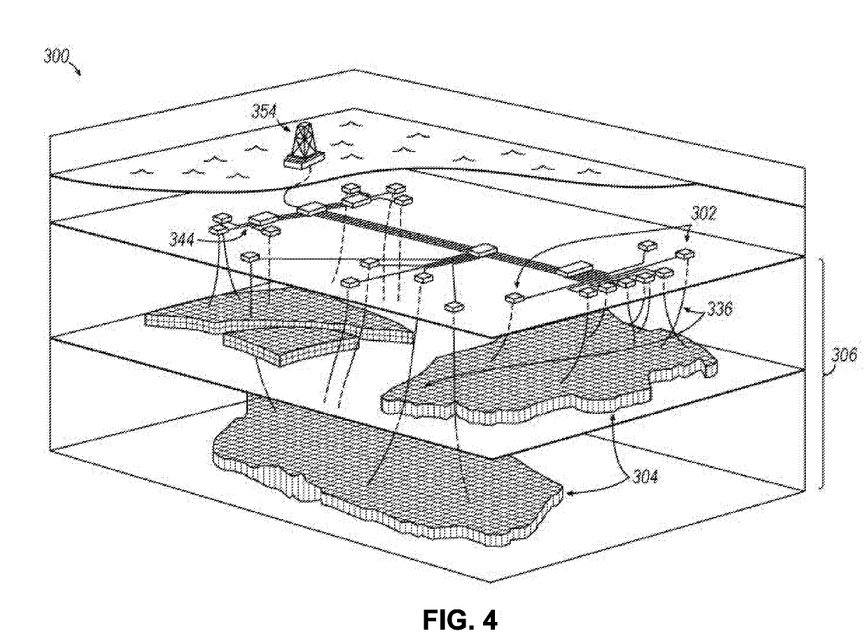

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Flow Control Device Design for Well Completions in an Oilfield

Embodiments consistent with the invention may be used, for example, to improve oilfield productivity and/or economic value, be it discounted or undiscounted for the time value of money, using various optimization techniques, static/autonomous/time-dependent flow control devices and reservoir simulation. Such embodiments may provide a technical effect in part by selecting a plurality of flow control devices, which, upon installation in an oilfield, may be used to optimize production in an oilfield.

As noted above, several different types of Flow Control Devices (FCDs) can be installed in a wellbore in order to improve overall oilfield productivity and worth, including various types of static Inflow Control Devices (ICDs), Autonomous Inflow Control Devices (AICDs), and active Flow Control Valves (FCVs).

In many conventional scenarios, a particular type of device is chosen for all wells in an oilfield under development, and in some instances, multiple devices may be installed within a single well. Static ICDs or autonomous AICDs may be configured prior to production/injection based on productivity/injectivity assessments calculated from initial reservoir and fluid parameters such as permeability, porosity and fluid phase behavior, or estimated from inflowing fluid properties in the case of AICDs. FCVs may have a fixed set of cross-sectional areas (apertures) or may have infinitely controllable apertures, and all of these types of FCDs may generally be used to regulate a pressure drop across an FCD in response to combinations of flow rate, inflowing mixture density and inflowing mixture viscosity, and the pressure drop across these various devices may be governed by a Bernoulli-like equation.

In embodiments consistent with the invention, however, a flow control device design may be generated for at least a portion of an oilfield to allow various types of ICDs, AICDs and/or FCVs to be selected for installation within single or multiple wells, and to select an “optimal” device type for each completion interval within a well or group of wells.

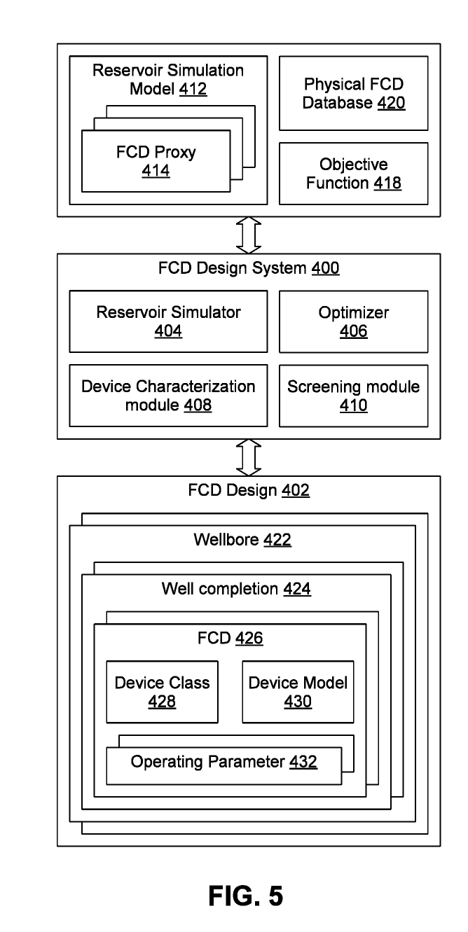

FIG. 5, for example, illustrates an example implementation of a flow control device design system 400 suitable for generating a flow control device design 402 in an environment such as data processing system 10 of FIG. 1. Flow control device design system 400, for example, may include a number of software components or modules that interact with one another to provide various functionality described herein, including, for example, a reservoir simulator 404, an optimizer 406, a device characterization module 408 and a sensitivity analysis module 410. It will be appreciated that additional components may be implemented in system 400, and that any of the components in the system may be implemented into a singular tool or product in some embodiments, or may be implemented in separate tools or products in other embodiments. Furthermore, the components in system 400 may be resident on the same or different physical computers in different embodiments.

Moreover, it will be appreciated that the functionality implemented by the components in system 400 may be implemented in some embodiments using automated operations from start to finish, while in other embodiments, user input may be used to transition between different operations, provide additional input data, and/or initiate certain operations such as running one tool or component upon completion of another tool or component. Additional user-performed operations may also be performed in connection with the operations performed by system 400. Further, in some embodiments, a workflow may be implemented to guide a user between different operations. The performance of certain operations in response to user input, however, does not detract from the fact that it is computer-implemented functionality in system 400 that generates a flow control device design 402.

As will become more apparent below, reservoir simulator 404 may be used to run reservoir simulations using a reservoir simulation model 412. Model 412 may be a model of an entire oilfield, or may be directed to a sector or region of the oilfield including simulated production and/or injection wells. As will also become more apparent below, model 412 may be equipped with generic flow control devices, referred to herein as flow control device proxies 414, whose optimal type will be determined by the herein-described functionality. Each well may have many devices of different types, each assigned to various completion intervals, or well completions.

The flow control device proxies 414 may be represented by at least one generalized expression for pressure drop that includes a plurality of tunable parameters associated with one or more physical flow control devices. In some embodiments, for example, a generalized Bernoulli equation, or other function or table, may be used, and may include multiple tunable parameters that can predict the pressure drop across a particular type of device used to control inflowing and/or outflowing fluids from a well. Specific tunable parameters may, for example, reflect device response to inflowing phase or component properties such as density, viscosity or flow rate, among others. This modelling of the proxies 414 may then be fitted to predict the response of physical or actual flow control devices. In addition, the generalized expression(s) for pressure drop through a device may additionally be further modified in some embodiments to permit a single expression for tunable approximation of pressure drop over both device and pipe.

Optimizer 406 may be coupled to reservoir simulator 404, and may be used to initiate multiple simulations of reservoir simulation model 412 using different combinations of values for the tunable parameters of the generalized expression(s) for pressure drop. Optimizer 406 may also rely on an objective function 418 that incorporates the tunable flow control device model parameters as optimization variables along with physical values related to oilfield development (e.g., cumulative production/injection) and/or other (e.g., economic) considerations. In some embodiments, for example, optimizer 406 may guide a series of reservoir simulations of oilfield recovery in order to find an optimum objective function, e.g., based in part on Net Present Value (NPV), such that optimized parameters will determine or select a suitable flow control device type to be used for each completion interval, and in some instances, one or more operational parameters or settings for each selected device. Some operational parameters may also be time-based, such that a particular operational setting such as a discharge coefficient may be changed during the production cycle.

Device characterization module 408 may be used to generate a physical flow control device database 420 including records corresponding to physical or actual flow control devices. Module 408, in particular, may use manufacturer, test data and/or other data to generate a set of tunable parameter values that characterize a particular flow control device, and that may be used to find a matching physical flow control device for a well completion based upon tunable parameter values generated for that well completion during optimization. It will be appreciated that database 420 may additionally include other information about physical flow control devices, including, for example, constraints that limit the applications in which a particular device can be used (e.g., limiting the use of a particular device to completions at less than a maximum depth or distance along a wellbore).

Screening module 410 may be used to screen an initial set of tunable parameters to choose a subset of tunable parameters from the initial set to reduce the solution space and thereby reduce the computational resources and/or computing time utilized in connection with generating a flow control device design 402. Screening module 410, for example, may be implemented in some embodiments as a sensitivity analysis module that applies a statistical method or information metric to assess and rank the sensitivity of the tunable parameters, e.g., as to the performance of individual types of flow control devices and the completion intervals to which they are assigned, in order to reduce the initial set to a reduced subset of tunable parameters having sufficiently strong objective function gradients to have a meaningful impact in the optimization.

It will also be appreciated that system 400 may be configured to iteratively implement the aforementioned functionality if an initial generation of flow control device design 402 is deemed insufficient. For example, in some embodiments if it is evident that optimum parameter values for a device selected for a certain completion interval are sufficiently “close to” those of a known physical flow control device, then parameter values for that device may be substituted for some of the tunable parameters for the generalized expressions of pressure drop implementing one or more of proxies 414, and the aforementioned operations may be repeated with fewer tunable parameters. Put another way, in some embodiments one or more proxies 414 may be iteratively “locked” to the parameters of known physical devices to narrow the solution space and incrementally achieve an optimized field-wide solution.

A flow control device design 402 may be implemented in a number of manners consistent with the invention. In some embodiments, and as illustrated in FIG. 5, a flow control device design may be operative for one or more wellbores (or wells) 422, each including one or more well completions (or completion intervals) 424, and may select one or more flow control devices 426 for each well completion. In some embodiments, flow control devices may be selected for multiple well completions in a single well or wellbore, while in other embodiments, flow control devices may be selected for one or more well completions in multiple wells or wellbores.

A flow control device 426 may be selected in different manners in different embodiments, and in the illustrated embodiments, selects at least a “type” for the flow control device. For some embodiments, for example, both a flow control device class 428 and a flow control device model 430 may be selected for a flow control device type. Device class 428 generally refers to different classes or categories of flow control devices, e.g., ICDs v. AICDs v. FCVs. Device model 430 generally refers to specific physical flow control devices, e.g., as identified by manufacturer, model number, or sets of physical characteristics. Thus, in some embodiments, a design may specify not only a class of flow control device (e.g., an AICD), but also a particular model of flow control device (e.g., a model XYZ AICD). In other embodiments, however, different types may be selected for a well completion. For example, some embodiments may select a class of flow control device without selecting a particular model. In addition, some embodiments may select a model of flow control device without selecting a class (e.g., where a decision is made to limit the search to just flow control devices of a particular class).

As will also become more apparent below, a flow control device 426 may also specify one or more operating parameters 432, e.g., aperture cross-section or other operational or control settings that affect the amount of flow permitted through the device. Operating parameters may also be time-based, e.g., to change flow at a particular point in time, or even to disable one flow control device and/or activate another flow control device installed in the same completion interval at a particular point in time. Other operating parameters that may be specified in a design 402 may include, for example, responses to surface facility capacity constraints, response to shut-off of neighboring wells (e.g., to make up for production short fall), etc.

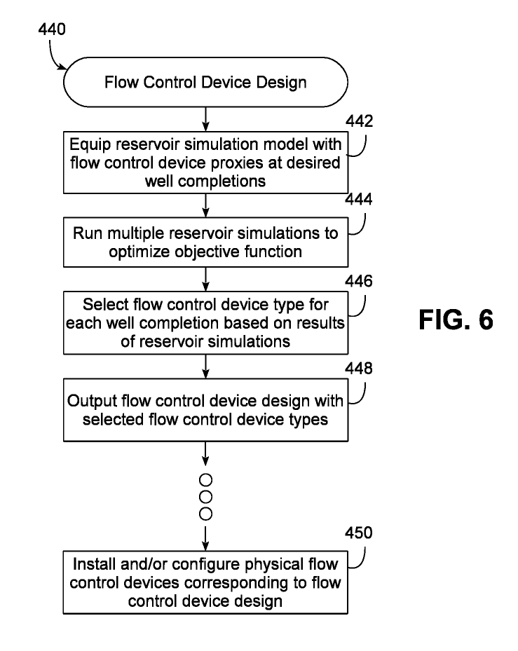

Now turning to FIG. 6, an example sequence of operations 440 capable of being implemented within system 400 of FIG. 5 is illustrated in greater detail. In this sequence of operations, a flow control device design is generated for a plurality of well completions in one or more wells in an oilfield. In block 442, a reservoir simulation model of at least a portion of the oilfield is equipped with the plurality of flow control device proxies represented by at least one generalized expression for pressure drop including a plurality of tunable parameters associated with one or more physical flow control devices. The equipping in block 442, in this regard, may be considered to include generating the proxies and incorporating the proxies into the reservoir model itself or otherwise providing the proxies to the reservoir simulator for use in a reservoir simulation.

Next, in block 444, multiple reservoir simulations are run to optimize an objective function based upon at least a subset of the plurality of tunable parameters to determine an optimal set of values for the at least a subset of tunable parameters. As will become more apparent below, running the reservoir simulations may include applying the at least one generalized expression for pressure drop using a plurality of sets of values for the at least a subset of tunable parameters, and selection of these sets of values may be guided or driven by an optimizer. Then, in block 446, a flow control device type (e.g., class and/or model) may be selected for each well completion among the plurality of well completions based at least in part upon the determined optimal set of values. A flow control device design, including at least the selected flow control device types, may then be output in block 448, e.g., in the form of a report or recommendation. In addition, as illustrated by block 450, in some embodiments the output design may be used to perform an oilfield operation such as installing and/or configuring one or more physical flow control devices corresponding to the design, maximizing recovery from the region around the well, maximizing net present value at some future point of time, reducing or delaying the impact and magnitude water conning or cresting, reducing or delaying gas cusping or coning, balancing an inflow profile along a well, encouraging conformance of the flood front (i.e., to make it more piston-like and to avoid premature breakthrough and fingering), etc.

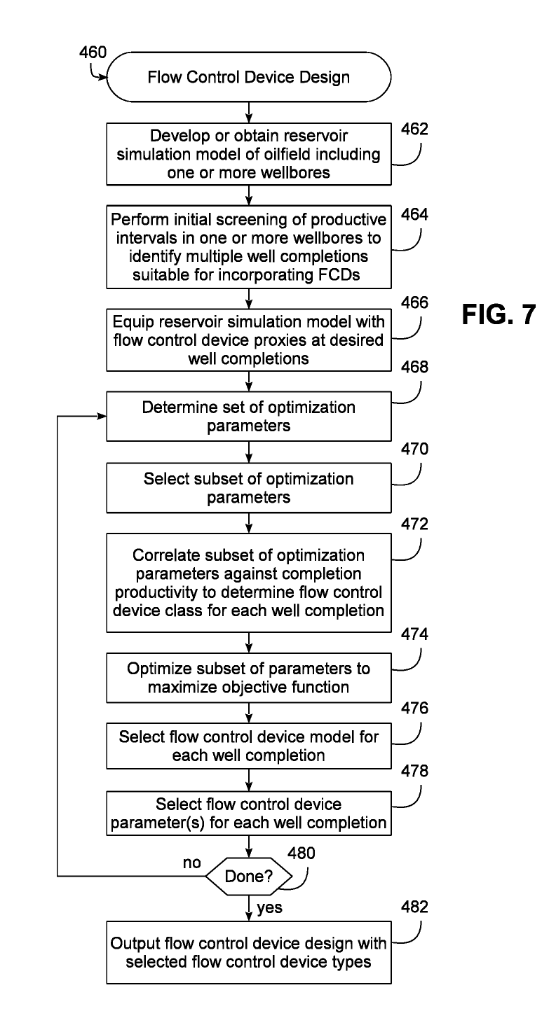

Now turning to FIG. 7, another example sequence of operations 460 is illustrated providing additional details regarding the implementation of the herein-described functionality in the generation of a flow control device design in a manner consistent with the invention. First, in block 462, a full or partial (sector) reservoir simulation model of an oilfield may be developed or otherwise obtained. In the illustrated embodiment, the reservoir simulation model may be capable of being validated against history so that one may have greater confidence in the response of the wells in the oilfield to various choking scenarios. In some embodiments, simulations using the model may constrain the wells to run on bottom hole pressure (BHP) control so that the flow control devices are the sole flow restriction within each well. Initially, in order to tune a simulation against history, or other data, rate control may be used, but for optimization purposes rate controls may also be approximated with BHP control so that device flow control does not compete with overall well control. Well completions in an initial simulation may also be open-hole in some embodiments.

Next, in block 464, an initial screening may be performed of productive intervals in multiple production and injection wells to determine a set of completion intervals, or well completions, where FCDs may be suitable for installation, e.g., using various automated and/or manual assessment techniques that will be apparent to those of ordinary skill in the art having the benefit of the instant disclosure.

Next, in block 466, the reservoir simulation model may be equipped with flow control device proxies at the desired well completions identified in block 464. The flow control device proxies each serve as a model of the pressure drop through a generic flow control device, and as noted above, the proxies may be represented by at least one generalized expression for pressure drop that includes a plurality of tunable parameters associated with one or more physical flow control devices. It will be appreciated that each proxy may be represented by an individual expression in some embodiments, while in some embodiments, multiple proxies may be represented by a combined generalized expression, and in some embodiments, a single generalized expression may represent all of the proxies.

A generalized Bernoulli equation to model inflow control devices with parameters including discharge coefficient and calibration parameters for flow rate, viscosity and density. This generalized Bernoulli equation in some embodiments may be implemented in a form such as Eq. (1) below:

$$Δ {P}_{form} = λ \frac{{C}_{u}}{2 {C}_{d}^{2} {A}_{c}^{2}} {{ρ}_{mix} ( \frac{{ρ}_{mix}}{{ρ}_{c al}} )}^{x} {( \frac{{μ}_{mix}}{{μ}_{c al}} )}^{y} {( \frac{\vert {q}_{dev} \vert}{{q}_{c al}} )}^{z} {q}_{dev} \vert {q}_{dev} \vert \qquad ( 1 )$$

### Here,

$$K = \frac{{C}_{u}}{2 {C}_{d}^{2} {A}_{c}^{2}}$$

is the base strength of the device, λ is the strength multiplier, ρₘᵢₓ is the mixture density, ρ_{cal} is the density of a fluid used to calibrate the device, μₘᵢₓ is the mixture viscosity, μ_{cal} is the calibration fluid viscosity, q_{dev} is the volumetric flow rate of the fluid mixture through the device at local conditions, q_{cal} the volumetric flow rate of the calibration cal fluid, x,y,z are tunable parameters or calibration exponents (e.g., density, viscosity and flow rate), Cᵤ is a unit conversion factor, C_{d} is a discharge (flow) coefficient specific to the device, and A_{c} is a representative cross-sectional area of the device constriction. The use of the subscript “form” on the left side of Eq. (1) distinguishes the pressure drop arising from the geometry of the device itself, and allows a friction component of the pressure drop to be linearly superposed using a Bernoulli equation that contains a friction factor in some embodiments.

This equation, however, is simply one method to model the pressure drop across a flow or inflow control device, and as such the invention is not limited to this particular equation. Alternative equations, functions or tables (e.g., look-up tables) may be used to describe similar behaviors. Furthermore, different numbers and combinations of tunable parameters may be used in other embodiments. While Eq. (1) uses three tunable parameters x,y,z to describe the device response to mixture density, mixture viscosity, flow rate, respectively, other parameters, e.g., parameters related to device strength such as discharge coefficient C_{d}, cross-sectional area A_{c}, inclination angle, θ, diameter of the main well conduit, D, etc., parameters related to phase slippage such as the drift velocity experienced by one phase as it slips over another phase, dimensionless groups, such as Reynolds number (for both single- and multi-phase fluids), Froude number, viscosity number, or other physical relations that characterize device sensitivity to inflowing fluids, may also be used in addition to or in lieu of those used in Eq. (1). In one example embodiment, for example, the tunable parameters for each generic flow control device may include a cross-sectional area parameter (A_{c}), a mixture density response parameter (x), a mixture viscosity response parameter (y) and a flow rate response parameter (z).

It will be appreciated that prior to generating a design, available physical flow control devices may be characterized (e.g., using device characterization module 408 of system 400, which may create characterization records in physical FCD database 420 corresponding to characterized physical flow control devices) using the same combination of tunable parameters to enable matching to occur when selecting flow control device types for individual well completion. In some embodiments, characterization may be based on the same parameters used for the proxies, while in other embodiments, characterization may be based on a superset of parameters such that different proxy implementations may use the same characterization data.

It will be appreciated that agreement between Eq. (1) and any specific physical flow control device need not be exact in some embodiments, as Eq. (1) may be used in some embodiments to broadly match flow characteristics of various broad classes of static, autonomous or time-dependent devices for the purpose of guiding a reservoir engineer towards installation of a device of a particular class (e.g., an ICD, AICD or FCV) for a particular well completion. Then, in some embodiments, when a class is selected, it may be desirable to either reduce or refine existing parameters to further select amongst available devices of that class, e.g., by utilizing a more detailed and/or specific fitting function or table for that class, or directly substituting a different function, or table, that exactly matches a selected device and remove all parameters for that well completion.

To illustrate this point further, Eq. (1) may be used in some embodiments to compare the effect cross-sectional area of an AICD with a similar effective ICD nozzle diameter, e.g., as shown in Eq. (2) below:

$$\frac{{A}_{eff AICD}}{{A}_{eff Nozzle ICD}} = \frac{{A}_{eff AICD}}{{C}_{d} {A}_{c}} = \sqrt{\frac{{C}_{u}}{2 {K ( \frac{{ρ}_{mix}}{{ρ}_{c al}} )}^{x} {( \frac{{μ}_{mix}}{{μ}_{c al}} )}^{y} {( \frac{\vert {q}_{dev} \vert}{{q}_{c al}} )}^{z}}} \qquad ( 2 )$$

Eq. (1) may also be extended further in some embodiments to include any number of dimensionless ratios and groups. For example, additional terms can be added to Eq. (1) to give the following Eq. (3):

$$Δ {P}_{form} = {λ}^{{C}_{λ}} \frac{{ρ}_{mix}}{2 {A}_{c}^{2}} {( \frac{{C}_{u}}{{C}_{d}^{2}} )}^{{C}_{S}} {q}_{dev} \vert {q}_{dev} \vert \cdot {\prod }_{i = 1}^{k} {( {f}_{i} ( {N}_{i} ) )}^{{C}_{i}} \qquad ( 3 )$$

where ƒᵢ may represent any function of dimensional ratios or groups Nᵢ, each with their own tunable parameters Cᵢ similar to the x, y, z seen in Eq. (1). Additional tunable parameters C_{λ},C_{S} may also be useful for modelling a set of devices with slight design changes that can, as a group, have a strength modifier λ and/or discharge coefficient C_{d}. The Nᵢ may include the ratios

$$\frac{{ρ}_{mix}}{{ρ}_{c al}} , \frac{{μ}_{mix}}{{μ}_{c al}} , \frac{\vert {q}_{dev} \vert}{{q}_{c al}}$$

seen in Eq. (1), or other any other dimensionless groups, for example Reynold's number Rₑ, Dean number D, Deborah number Dₑ, Archimedes number Aᵣ, etc.

It will therefore be appreciated by those of ordinary skill in the art having the benefit of the instant disclosure that a wide variety of generalized expressions may be used to represent proxies in different embodiments. Therefore, the invention is not limited to the particular expressions disclosed herein.

With continued reference to FIG. 7, after the reservoir simulation model has been equipped with flow control device proxies, block 468 may next determine a set of optimization parameters upon which to perform an optimization. In some embodiments, for example, an initial set of optimization parameters may be established following an initial assessment by a reservoir engineer. For example, if a completion interval has a higher flow rate, the initial assessment may be that an appropriate device for this completion interval is a flow control valve with a time-dependent parameter such as a discharge coefficient or cross-sectional area. As another example, if a simulation is run over a twenty year production period, an initial set of optimization parameters may include a discharge coefficient for each year of production. In one example scenario, for example, an optimization may use FCV settings set at multiple times during a period, with several productive compartments each having a set of time-dependent FCV settings.

Another scenario may be that a particular completion does not have the productivity (determined using standard completion engineering principles and techniques) to warrant a more expensive FCV, but may be amenable to installation of an AICD or ICD. The optimization parameters for this particular device installed in this completion may include parameters such as x,y,z and device strength, as described above. An optimization step may then determine that the tuning parameters x,y,z are too weak to justify an AICD but that the discharge coefficient or cross-sectional area is sufficiently strong as an optimization parameter to justify installation of an ICD at this measured depth. It is also possible in some embodiments to simply set every completion interval within all wells to have a generic model such as Eq. (1), but the overall process may be made more efficient by a reservoir engineering guided initial assessment.

Next, in block 470, a subset of optimization parameters may be selected from the initial set of optimization parameters, in part to reduce the number of parameters used in the optimization and thereby reduce the complexity, computing resources and/or computing time for performing the optimization. In some embodiments, for example, block 470 may include an initial sampling of simulation results, including running a simulation over a specified period of time in order to determine physical values pertinent to the field such as cumulative production, rates, cumulative injection, etc. Then a desired objective function such as Net Present Value (NPV) may be determined or calculated.

It will be appreciated that one concern with any optimization procedure is the high number of optimization parameters that may potentially be involved when an objective function is computationally expensive to evaluate and/or the optimization procedure is otherwise computationally demanding. Thus, to mitigate this cost and improve the search capability by focusing only on critical optimization parameters in the problem, a screening procedure such as sensitivity analysis may be used in some embodiments. A number of simulation evaluations may be made at the outset by sampling the collective search space described by all possible optimization parameters, e.g., using random (e.g., Monte-Carlo methods), pseudo-random (e.g., Sobol-type methods) or based on definitive configurations stemming from design of experiments, etc. The sampling may include running a plurality of reservoir simulations using the reservoir simulation model and differing values for each tunable parameter and then determining a sensitivity for each tunable parameter based on the simulation results.

The sampling process may serve to provide a measure of the variability of the system that can be assessed using any number of statistical methods, such as analysis of means, analysis of variances, principle component analysis, or SVD, amongst others. The optimization parameters with the largest contribution to the variability may then be retained for optimization purposes. That is, depending on user choice, the optimization parameters describing some ratio of the total variability may be selected for optimization in some embodiments, thereby ensuring that insensitive parameters do not unduly restrict or impede the optimization process so that better and more efficient solutions can be obtained.

Another approach that may be adopted in some embodiments to address the problem of too many optimization parameters in any given time-dependent optimization process where operational flexibility is important (such as that provided by AICDs and FCVs), is to use a “rolling optimization policy,” which effectively divides the simulation run-time into time-increments, within which a tractable (i.e., practical or reasonable) number of optimization parameters may be defined. Such a process may start at t=0 (simulation start time) and optimize the next time period (which may be a year, a quarter or another suitable time period). The optimal control set for that time period (say t=t0 to t=t1) may then be used as the starting point for the next time-interval (say t=t1 to t=t2), and these operations may be repeated until the simulation period (i.e., end of simulation (EoS)) has been reached (i.e., t=tEoS). The results of this “rolling optimization policy” may then be interrogated to establish the relative sensitivities of each optimization parameter, either globally or within each time interval, which may then be ranked and reduced to fit the general expression. This approach may also be used in some embodiments alongside the aforementioned Sobol-type sampling scheme.

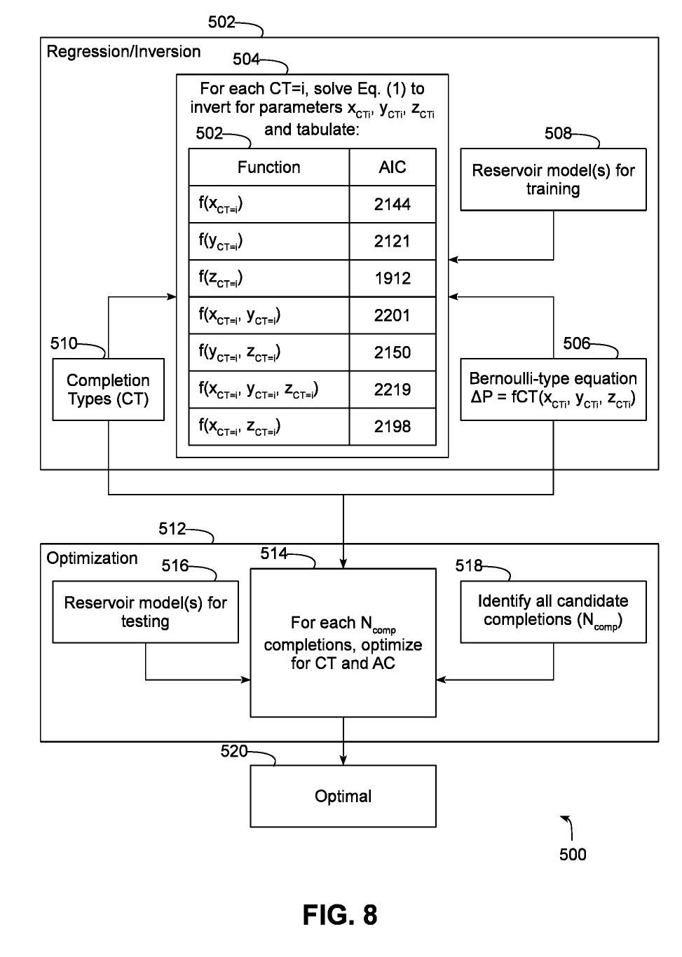

Yet another approach that may be used in some embodiments may be to utilize causal analytics, e.g., as illustrated at 500 in FIG. 8 where a regression/inversion block 502 computes in block 504 various combinations of fitted optimization parameters of a generalized expression 506 using a training set 508, and based on various completion types (CTs) 510 (e.g., open, ICD, AICD, FCV, Manara FCV, etc.). In some embodiments, for example, each possible combination of fitted expression variables (x, y and z) for each completion type (i.e., CT=i) may be fitted, along with their associated information metric, e.g., including an Akaiki Information Criteria (AIC), and used to generate a table 502 providing a rapid look-up, ordered according to AIC. Such an information-metric-driven outcome may then be fed into an optimization block 512 to determine in block 514 and based upon a testing data set 516 and a set of candidate completions 518 an optimal configuration 520 of candidate completions. In some embodiments, this optimization may use a different testing set 516 from training set 508.

Returning to FIG. 7, and irrespective of how the subset of optimization parameters is selected, block 472 correlates the subset of optimization variables against completion productivity in order to determine a flow control device class for each well completion, e.g., to determine whether the most appropriate device for a particular completion interval is a static ICD, autonomous AICD or time-dependent flow control device or FCV. In some embodiments, block 472 may be manually implemented, but in other embodiments, block 472 may be automated such that a particular measure of correlation amongst individual types or groups of optimization parameters may be used to guide the decision on the class of device chosen.

For example, in one implementation, if a particular completion interval shows a strong sensitivity with respect to discharge coefficient and also a strong ranking with flow rate while a weaker correlation against density and viscosity, then the choice may be to set the class of device appropriate to this completion interval as a flow control valve and, initially, to assign several operational parameters on a time-dependent basis. If the ranking shows dependency on density or viscosity, then the appropriate device class for this completion interval may be an autonomous device, e.g., an AICD. On the other hand, if the ranking shows a linear strength only in discharge coefficient or cross-sectional area, then the appropriate device may be a static ICD.

Next, in block 474, optimization is performed of the selected subset of optimization parameters to maximize an objective function, e.g., an economic output metric such as improved NPV or some other objective function based upon various economic and/or oilfield development factors (e.g., production rates or amounts, capital expenditure costs, maximize oil recovery, promoting oil production while penalizing non-revenue-generating fluids, such as water, maximizing some conformance metric that is used within the reservoir simulator to maintain an even inflow profile along the well, or sections of the well, maintain conformance of a steam chamber if the flow control devices are used in SAGD developments and so on), along with the tunable parameters, as will be apparent to those of ordinary skill in the art. One objective function for use in some embodiments, for example, may factor the capital expenditure costs of the different completion options along with other production-related factors. The optimization, as noted above, may incorporate running a plurality of reservoir simulations using different combinations of values for the selected subset of optimization parameters to attempt to determine an optimum set of values for the subset of optimization parameters, and may be controlled by an optimizer that operates on various optimization algorithms, including random (e.g., Monte-Carlo methods), pseudo-random (e.g., Sobol-type methods), derivative-free schemes such as downhill simplex, proxy methods, such as neural networks and radial basis functions, evolutionary algorithms such as genetic algorithm, and also derivative-based approaches such as the conjugate gradient method or others or other optimization approaches. In some embodiments, an efficient frontier approach may also be used to attempt to maximize expected utility while minimizing uncertainty.

Next, in block 476, a flow control device model may be selected for each well completion from the optimum set of values for the subset of optimization parameters. In some embodiments, for example, physical FCD database 420 (FIG. 5) may be searched to identify one or more potential matches between physical flow control devices and parameter values determined from the optimization and relevant to a particular well completion, with one or more closest matches being recommended for use at that well completion.

In addition, as illustrated in block 478, in some embodiments, it may also be desirable to propose operational settings or parameters for at least some of the proposed flow control devices. For example, where an optimal value for a cross-sectional area parameter for an FCV is determined from optimization, it may be desirable to propose an operating parameter that controls that FCV to use that cross-sectional area during production.

Furthermore, in some embodiments, additional time parameters may be selected in block 478. A time parameter, for example, may control when an associated operating parameter is set or changed for a particular flow control device. In addition, in some embodiments, workovers may be considered, whereby, for example, static flow control devices that may be more suited for an initial production period may be replaced by controllable or autonomous devices at a later date. Such a decision may be driven, for example, by economics that balance workover cost with initial savings from deploying ICDs, and as such, the herein-described sequence of operations may be used to select multiple flow control devices for a given well completion and/or propose a time parameter that controls when to switch a well completion from one flow control device to another.

Block 480 next determines whether to repeat blocks 458-478. For example, in some embodiments, blocks 458-478 may be repeated until no further gains in productivity are detected, as measured against some measure of productivity established for the process. In other embodiments, however, a single pass of blocks 458-478 may be sufficient. Thus, when no additional iterations are determined, block 480 passes control to block 482 to output a flow control device design including the selected flow control device types, e.g., including one or more of flow control device classes, flow control device models, and operating parameters for each well completion.

It will be appreciated that the resulting flow control device design may provide a scenario where the final outcome may be a scenario where some completion intervals have static ICD devices, others have autonomous AICD devices, and still others have active FCV devices where timing of the valve settings is a factor. Some scenarios may also suggest future workovers.

Various modifications may be made in other embodiments. For example, in some embodiments, some flow control device proxies may be tuned based on local flow conditions, e.g., based on collected field data whenever available, and further, whenever it is known that certain physical flow control devices are or will be installed in particular well completions, the proxies therefor may be “locked” and the parameters therefore removed from the optimization and replaced with actual values corresponding to those devices.

Sampling or sensitivity analysis may also be performed iteratively in some embodiments to progressively decrease the number of optimization parameters, with values for optimization parameters removed from the subset fixed for subsequent iterations and for optimization.

It may also be desirable in some embodiments to manage parametric uncertainty, e.g., due to geological, petro-physical, or other factors inherent in the models used. It will be appreciated that some approaches to optimizing under uncertainly may rely on a decision-maker to define a utility for the outcome of each realization of the uncertainty, and then maximize the expected utility. For each objective function evaluation, this may necessitate function evaluations for each realization of interest. However, it will be appreciated that a decision maker may not know the utility function a priori, and so it may be more beneficial in some embodiments to present a variety of solutions that are optimal according to some non-utility-based criterion. One way of achieving this in some embodiments is to construct what is known as an efficient frontier, where each point on the frontier represents a trade-off between maximizing the expected result (the mean) and minimizing the uncertainty (the standard deviation). In this regard, a confidence factor (or risk aversion factor) lambda may be introduced to create a composite objective defined as F=mu−lambda(sigma), where mu is the mean and sigma is the standard deviation of the set of realizations (taken over the parametric uncertainty space) that account for the variability of the model at a given design configuration X. The optimization of the given composite function may yield a collection of samples along with an optimal anticipated solution. The efficient frontier may be realized when several such problems are solved with differing values of lambda. The collection of samples obtained highlight the efficient frontier, with the points indicating preferential operating configurations, and the greater the value of lambda selected the greater the certainty that the expected result can be obtained. For smaller values of lambda (including zero that concerns optimization of the mean response), the function value is high, but the certainty is lower. Overall, the outer convex hull of the samples identifies the efficient frontier on which the desired operating point may be selected, either autonomously or by a decision maker. Generally so long as uncertain parameters are sampled sufficiently to quantify the effect on the model (i.e., to account for the variability, parametric uncertainty (e.g., in terms of viscosity, density, etc.) may be included as part of the techniques described herein. Thus, in some embodiments, an optimization (e.g., in block 444 of FIG. 6) may include optimizing an objective function under geological and/or petro-physical uncertainty to identify a plurality of optimal solutions based at least in part on a non-utility-based criterion.

Further, in some embodiments, an inference procedure may be used to map prevailing solution parameters at a given location along a well to particular device types. An inference engine may be based on rules (from experience), fuzzy-set theory, a Bayesian representation or in some other manner. In any case, solution properties may be converted into device assignment by an appropriate mapping (inference) procedure. Such a process may use data from many initial trial evaluations of devices in various well configurations and varying reservoir properties in order to capture the anticipated rule structure.

In addition, in some embodiments, constraints on flow control devices may also be factored explicitly into the mapping of the solution space. For example, in-line hydraulically-actuated FCVs generally have a depth or distance limit that precludes their use below a certain depth or beyond a certain distance from a wellhead. If the herein-described optimization process establishes the utility of adjustable completions along a well, this discovery may be complemented by adding such a constraint, which effectively tests the ability to operate the device as a function of measured depth. For example, if a device is set too deep then the objective function may be updated by replacing such devices with Manara-type FCVs (which generally may be located further along a well).

Further, in some embodiments, some flow control device proxies may be constrained prior to running reservoir simulations based upon factors such as flow rate at an associated well completion, productivity of an associated well completion, or a physical constraint of an associated well completion, thereby limiting what physical flow control devices may be selected for certain well completions to those meeting any established constraints.

Although the preceding description has been described herein with reference to particular means, materials, and embodiments, it is not intended to be limited to the particular disclosed herein. By way of further example, embodiments may be utilized in conjunction with a handheld system (i.e., a phone, wrist or forearm mounted computer, tablet, or other handheld device), portable system (i.e., a laptop or portable computing system), a fixed computing system (i.e., a desktop, server, cluster, or high performance computing system), or across a network (i.e., a cloud-based system). As such, embodiments extend to all functionally equivalent structures, methods, uses, program products, and compositions as are within the scope of the appended claims. In addition, while particular embodiments have been described, it is not intended that the invention be limited thereto, as it is intended that the invention be as broad in scope as the art will allow and that the specification be read likewise. It will therefore be appreciated by those skilled in the art that yet other modifications could be made without deviating from its spirit and scope as claimed.

What is claimed is:

1. A method of generating a flow control device design for a plurality of well completions in one or more wells in an oilfield, the method comprising:
equipping a reservoir simulation model of at least a portion of the oilfield with a plurality of flow control device proxies, each flow control device proxy associated with a well completion among the plurality of well completions, the plurality of flow control device proxies represented by at least one generalized expression for pressure drop including a plurality of tunable parameters associated with one or more physical flow control devices;
running a plurality of reservoir simulations using the reservoir simulation model to optimize an objective function based upon at least a subset of the plurality of tunable parameters to determine an optimal set of values for the at least a subset of tunable parameters, wherein running the plurality of reservoir simulations includes applying the at least one generalized expression for pressure drop using a plurality of sets of values for the at least a subset of tunable parameters; and
selecting at least one flow control device type for each well completion among the plurality of well completions based at least in part upon the determined optimal set of values.

2. The method of claim 1, wherein the flow control device type is selected from the group consisting of an inflow control device (ICD), an autonomous inflow control device (AICD) and a flow control valve (FCV).

3. The method of claim 1, wherein the flow control device type is selected from a plurality of models of flow control devices.

4. The method of claim 1, wherein running the plurality of reservoir simulations further includes determining an optimal value for one or more operating parameters for a flow control device type selected for a well completion among the plurality of well completions.

5. The method of claim 4, wherein the operating parameter includes a cross-sectional area.

6. The method of claim 1, wherein running the plurality of reservoir simulations further includes determining a time parameter controlling when to switch a well completion from a first flow control device to a second flow control device or controlling when to change an operating parameter from a first value to a second value.

7. The method of claim 1, wherein the objective function incorporates the at least a subset of tunable parameters, one or more oilfield development values and one or more economic values.

8. The method of claim 1, further comprising selecting the at least a subset of tunable parameters from the plurality of tunable parameters by performing sensitivity analysis on the plurality of tunable parameters.

9. The method of claim 8, wherein performing sensitivity analysis on the plurality of tunable parameters includes:
sampling simulation results by running a second plurality of reservoir simulations using the reservoir simulation model and differing values for each tunable parameter among the plurality of tunable parameters; and
determining a sensitivity for each tunable parameter among the plurality of tunable parameters based upon the sampled simulation results.

10. The method of claim 9, wherein sampling simulation results includes selecting the differing values using a Monte-Carlo or pseudo-random algorithm.

11. The method of claim 1, further comprising tuning at least one flow control device proxy among the plurality of flow control device proxies based on local flow conditions.

12. The method of claim 1, wherein the at least one generalized expression for pressure drop includes a respective generalized expression for pressure drop for each of the plurality of flow control device proxies, and wherein the plurality of tunable parameters includes multiple tunable parameters for each of the respective generalized expressions for pressure drop.

13. The method of claim 12, wherein at least one of the respective generalized expressions for pressure drop includes a generalized Bernoulli equation.

14. The method of claim 12, wherein the multiple tunable parameters for each of the respective generalized expressions for pressure drop includes a cross-sectional area parameter, a mixture density response parameter, a mixture viscosity response parameter and a flow rate response parameter.

15. The method of claim 1, further comprising constraining one or more flow control device proxies prior to running the plurality of reservoir simulations based upon one or more of flow rate at an associated well completion, productivity of an associated well completion, or a physical constraint of an associated well completion.

16. The method of claim 1, further comprising characterizing each of a plurality of physical flow control devices with an associated set of values for at least a subset of tunable parameters, wherein selecting the at least one flow control device type includes matching the optimal set of values against the associated sets of values for physical flow control devices among the plurality of physical flow control devices.

17. The method of claim 1, further comprising installing and/or configuring a plurality of physical flow control devices in the oilfield based upon the selection of the at least one flow control device type for each well completion.

18. The method of claim 1, wherein running the plurality of reservoir simulations to optimize the objective function further includes optimizing the objective function under geological and/or petro-physical uncertainty to identify a plurality of optimal solutions based at least in part on a non-utility-based criterion.

19. An apparatus, comprising:
at least one processing unit; and
program code configured upon execution by the at least one processing unit to generate a flow control device design for a plurality of well completions in one or more wells in an oilfield by:
equipping a reservoir simulation model of at least a portion of the oilfield with a plurality of flow control device proxies, each flow control device proxy associated with a well completion among the plurality of well completions, the plurality of flow control device proxies represented by at least one generalized expression for pressure drop including a plurality of tunable parameters associated with one or more physical flow control devices;
running a plurality of reservoir simulations using the reservoir simulation model to optimize an objective function based upon at least a subset of the plurality of tunable parameters to determine an optimal set of values for the at least a subset of tunable parameters, wherein running the plurality of reservoir simulations includes applying the at least one generalized expression for pressure drop using a plurality of sets of values for the at least a subset of tunable parameters; and
selecting at least one flow control device type for each well completion among the plurality of well completions based at least in part upon the determined optimal set of values.

20. A program product, comprising:
a computer readable medium; and
program code stored on the computer readable medium and configured upon execution by at least one processing unit to generate a flow control device design for a plurality of well completions in one or more wells in an oilfield by:
equipping a reservoir simulation model of at least a portion of the oilfield with a plurality of flow control device proxies, each flow control device proxy associated with a well completion among the plurality of well completions, the plurality of flow control device proxies represented by at least one generalized expression for pressure drop including a plurality of tunable parameters associated with one or more physical flow control devices;
running a plurality of reservoir simulations using the reservoir simulation model to optimize an objective function based upon at least a subset of the plurality of tunable parameters to determine an optimal set of values for the at least a subset of tunable parameters, wherein running the plurality of reservoir simulations includes applying the at least one generalized expression for pressure drop using a plurality of sets of values for the at least a subset of tunable parameters; and
selecting at least one flow control device type for each well completion among the plurality of well completions based at least in part upon the determined optimal set of values.
